(19) United States
(12) Patent Application Publication
(10) Pub. No.: US 2016/0084450 A1
(43) Pub. Date: Mar. 24, 2016

(54) LED Projector Capable of Emitting Light in 180°

(71) Applicant: NINGBO GEMAY INDUSTRY CO., LTD, Ningbo (CN)

(72) Inventors: Jining HU, Jinhua (CN); Bing HE, Jinhua (CN)

(73) Assignee: NINGBO GEMAY INDUSTRY CO., LTD

(21) Appl. No.: 14/570,526

(22) Filed: Dec. 15, 2014

(30) Foreign Application Priority Data
Sep. 18, 2014 (CN) 201420534544.1
Oct. 29, 2014 (CN) 201420632126.6

(51) Int. Cl. F21K 99/00; F21V 13/02; F21V 23/06; F21V 15/01; F21V 29/74; F21V 21/14; F21V 7/00; F21V 1/02

(52) U.S. Cl. CPC F21K 9/50; F21V 7/0016; F21V 7/0066; F21V 13/02; F21V 1/02; F21V 15/01; F21V 29/74; F21V 21/14; F21V 23/06; F21Y 2101/02

(57) ABSTRACT

An LED projector capable of emitting light in 180°, which includes a projector body; a power supply; a reflector cup; a lampshade; and a lampshade frame; a lamp seat having a pair of symmetrical inclined planes, an angle between the vertical center lines of the two inclined planes is between 30° and 90°; and two integrated LED lamps, each LED lamp being fixed on an inclined plane of the lamp seat, wherein the reflector cup has a bulge, and the bulge has two light projection holes for receiving the integrated LED lamps. The LED projector has a simple and rational configuration with easy assembly, and has large range of irradiation, good light condensation effect and balanced light.

### RELATE APPLICATIONS

This application claims the benefits of Chinese Invention Application 201420534544.1, filed on Sep. 18, 2014, and Chinese Invention Application 201420632126.6, filed on Oct. 29, 2014, the specifications of which are incorporated herein by this reference.

### FIELD OF THE INVENTION

The present invention relates to the technical field of semiconductor illumination, and particularly to an LED projector capable of emitting light in 180°.

### DESCRIPTION OF THE PRIOR ART

At present, as a new generation of solid-state lighting, LEDs have the characteristics of low heat, high lighting efficiency, long service life and the like. With the continuous breakthrough of the LED technology, particularly with the successful development of high-power and high-efficiency LEDs, LEDs have been widely applied in the field of projectors in addition to the common lighting fixtures. LED projectors are mainly applied in building wall lighting, indoor local lighting, lighting of outer walls of historical building groups, tree and flower landscape lighting, billboard lighting, atmospheric lighting for bars, ballrooms and other entertainment venues, site construction and maintenance lighting, lighting for work and the like.

For the existing single-lamp projectors, due to the unidirectional LED light emitting, such LED projectors when turned on have a maximum light emitting angle of 120°, and are unable to provide a larger angle and also unable to irradiate a certain angle; meanwhile, the light emitting intensity in the front of an LED projector is higher than that on the periphery, with some regions irradiated by very little light and some regions even irradiated by no light, so that there will be dark regions when large-angle lighting is required. Thus, the characteristics of this structure, i.e., monotonic light emitting angle and non-uniform light emitting effect, directly influence the popularization and application of this product. Therefore, many manufacturers and people of insight have made efforts in the developments and studies. Unfortunately, no ideal products have been found in the market.

### SUMMARY OF THE INVENTION

It is the object of the present invention to provide an LED projector capable of emitting light in 180°, with simple and rational structure, convenient installation and use, excellent focusing effect, balanced light and large irradiation range.

For achieving the above stated object, an LED projector capable of emitting light in 180°, comprises a projector body having a front surface, a back, and a center; a power supply connected to the projector body; a reflector cup disposed on the front surface; a lampshade; and a lampshade frame; a lamp seat, having a pair of symmetrical inclined planes, each inclined plane having a center line, is disposed in the center of the projector body, an angle between the vertical center lines of the two inclined planes is between 30° and 90°; and two integrated LED lamps, each LED lamp being fixed on an inclined plane of the lamp seat, wherein the reflector cup has a bulge fitted with the lamp seat, and the bulge has two light projection holes for receiving the integrated LED lamps.

Preferably, the two inclined planes of the lamp seat are symmetrically arranged left and right to be parallel to the ground, or, symmetrically arranged up and down to be vertical to the ground.

Preferably, the angle between the vertical center lines of the two inclined planes is 60°.

To be convenient to fix the projector body and the lampshade and to avoid the influence of outside dust or water on the illumination and safety of the projector, the lampshade is fixed on the projector body by pressing the lampshade frame toward the projector body, and a sealing ring is provided between the lampshade and the projector body to form a waterproof and dustproof sealed structure.

To improve the heat dissipation efficiency of the projector, a plurality of longitudinal cooling blades attached to the back of the projector body.

For convenience, a mounting support assembly is movably connected to the projector body for adjusting an illumination angle.

For safety, the power supply is provided with a waterproof connector connected to a power line.

Compared with the prior art, in the invention,

1. Since the two integrated LED lamps are correspondingly fixed on the symmetrical inclined planes of the lamp seat, by the arrangement of the included angle β between the two symmetrical inclined planes, the two high-power integrated LED lamps enable the horizontal or longitudinal illumination angle of the whole fixture to reach 180° through a grading combination, so that the whole lamp has large range of irradiation, good light condensation effect under the grading effect of the reflector cup, and balanced light, so that dark regions are avoided.

2. Since a waterproof and dustproof sealed structure is provided between the transparent lampshade and the projector body, the projector may be used in severe places and environments.

3. Since longitudinally arranged cooling blades are provided on the back surface of the projector body, air may flow up and down between the cooling blades, thereby quickening the heat exchange rate and improving the heat dissipation efficiency.

4. The angle of projection of the projector may be adjusted by the mounting support assembly capable of adjusting the illumination angle.

### BRIEF DESCRIPTION OF THE DRAWINGS

FIG. 1 is a perspective view of an LED projector in accordance with the first embodiment of the present invention;

FIG. 2 is a front view of the LED projector in accordance with the first embodiment of the present invention;

FIG. 3 is a sectional view of FIG. 2 in direction A-A;

FIG. 4 is an exploded view of the LED projector in accordance with the first embodiment of the present invention;

FIG. 5 is a perspective view of the LED projector in accordance with the second embodiment of the present invention;

FIG. 6 is a front view of the LED projector in accordance with the second embodiment of the present invention;

FIG. 7 is a sectional view of FIG. 6 in direction B-B;

FIG. 8 is an exploded view of the LED projector in accordance with the second embodiment of the present invention.

### DETAILED DESCRIPTION OF THE PREFERRED EMBODIMENT

To enable a further understanding of the innovative and technological content of the invention herein refer to the detailed description of the invention and the accompanying drawings below:

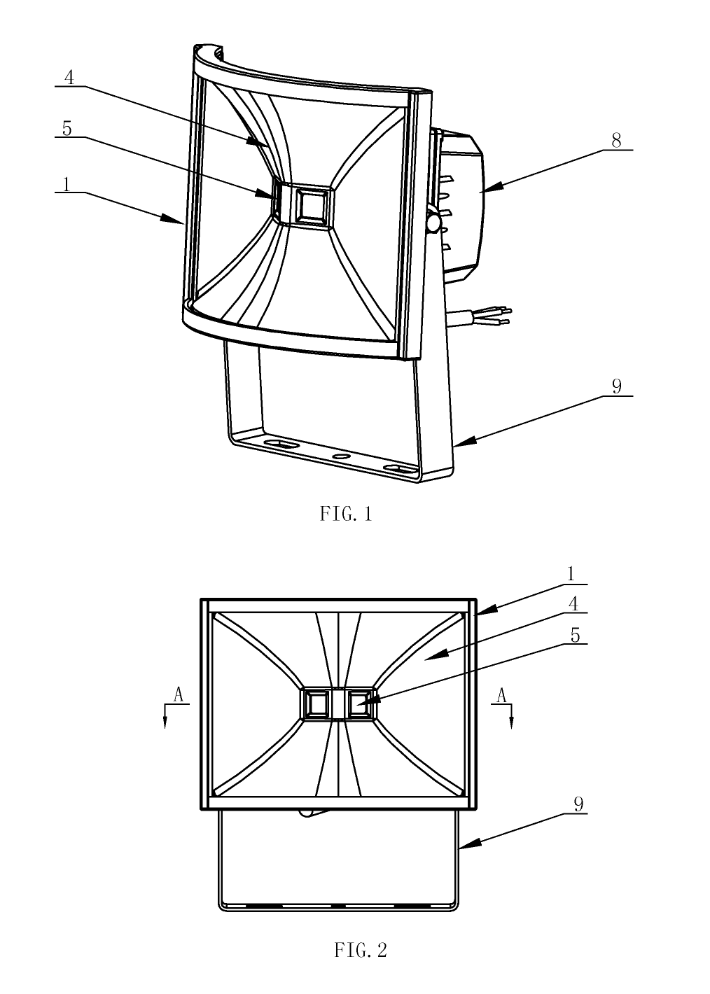

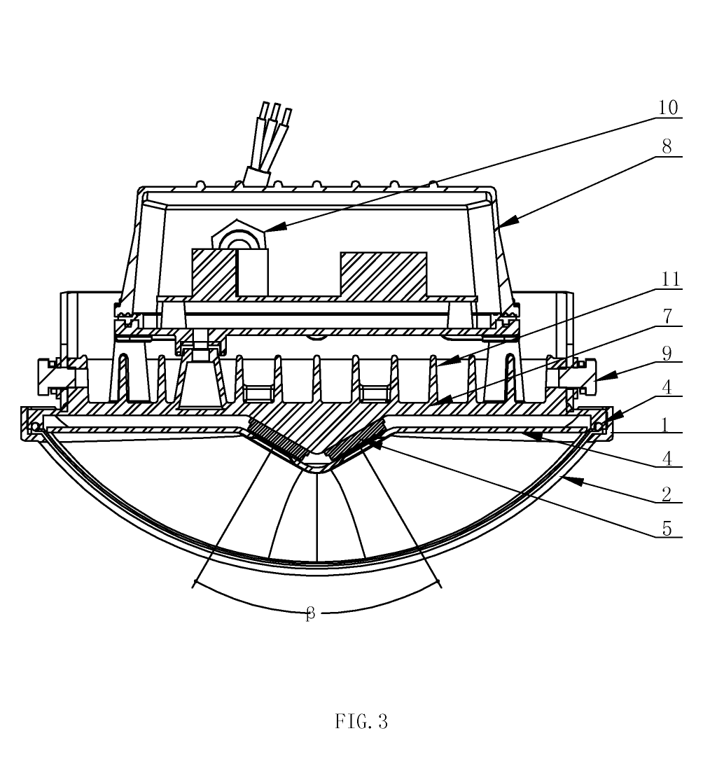

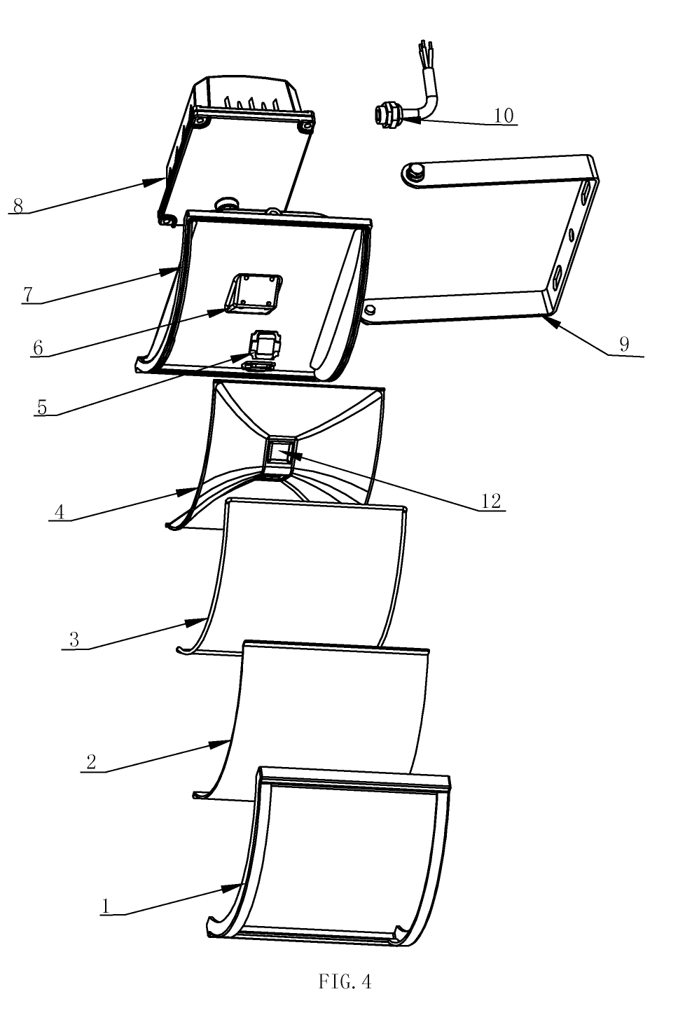

As shown in FIGS. 1 to 4, an LED projector capable of emitting light in 180° comprises a lampshade frame 1, a lampshade 2, a sealing ring 3, a reflector cup 4, two integrated LED lamps 5, a lamp seat 6, a projector body 7, a power supply 8, a mounting support assembly 9, a waterproof connector 10 and cooling blades 11.

The lampshade 2 is made of transparent material which may be transparent glass or transparent plastics, etc. The lampshade 2 is hemispherical and fixed on the front surface of the projector body 7 by pressing the circumferential edge of the lampshade 2 by the lampshade frame 1.

The lamp seat 6 is disposed in the center of the front surface of the projector body 7, and the top of the lamp seat 6 is protruded towards the lampshade 2.

The lamp seat 6 has a pair of symmetrical inclined planes, and the two inclined planes of the lamp seat are symmetrically arranged left and right to be parallel to the ground.

An angle β between the vertical center lines of the two inclined planes is between 30° and 90°, possibly 30°, 40°, 50°, 70°, 80° or 90°. In this embodiment, the angle β is 60°. Two integrated LED lamps 5, each LED lamp is fixed on an inclined plane of the lamp seat 6, so that the reflector cup 4 has a transverse projection angle of 180° and a longitudinal projection angle of 120°.

In order to ensure that the projector may be used in severe places and environments, a sealing ring 3 is provided between the lampshade 2 and the projector body 7 to form a waterproof and dustproof sealed structure, thereby effectively avoiding the influence of outside dust or water on the integrated LED lamps 5 inside.

The power supply 8 is connected to the back of the projector body 7. The power supply 8 is electrically connected to the integrated LED lamps 5 so as to supply power to the integrated LED lamps 5 and to control the integrated LED lamps 5.

In order to effectively seal a power line, the power supply 8 is provided with a waterproof connector 10 connected to a power line so as to ensure the electricity safety of the projector.

In order to improve the heat dissipation effect, a plurality of longitudinal cooling blades 11 are attached to the back of the projector body 7, so that air may flow up and down between the cooling blades 11. Thus, heat generated when the LED lamps 5 light can be effectively carried away, and heat generated during the working of the power supply 8 may also be carried away.

In order to adjust the illumination angle of the projector, a mounting support assembly 9 is movably connected to the projector body for adjusting an illumination angle, two ends of the mounting support assembly 9 are respectively connected to two sides of the projector body 7, and the projector body 7 is rotatable connected to the mounting support assembly 9. By rotating the projector body 7, the illumination angle of the projector may be adjusted conveniently.

### Embodiment 2

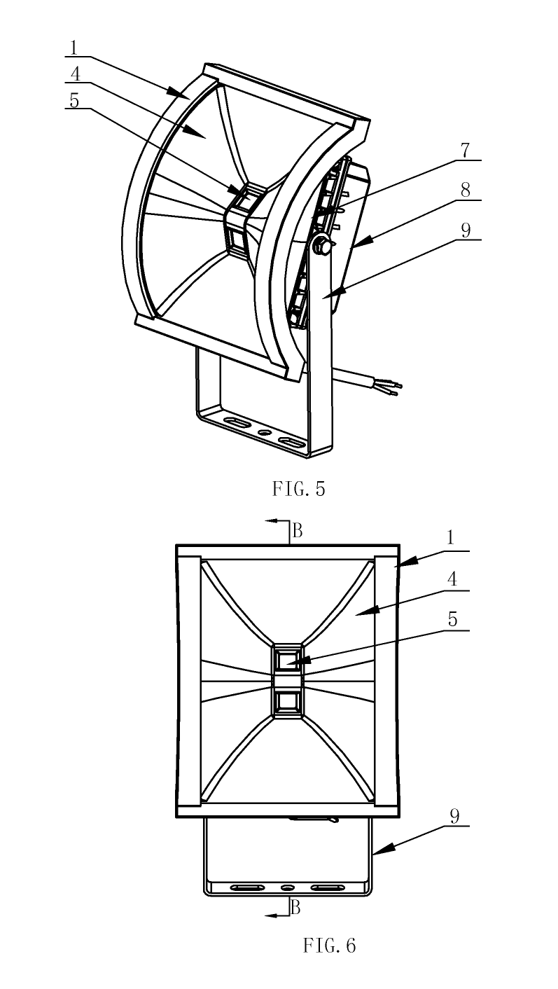

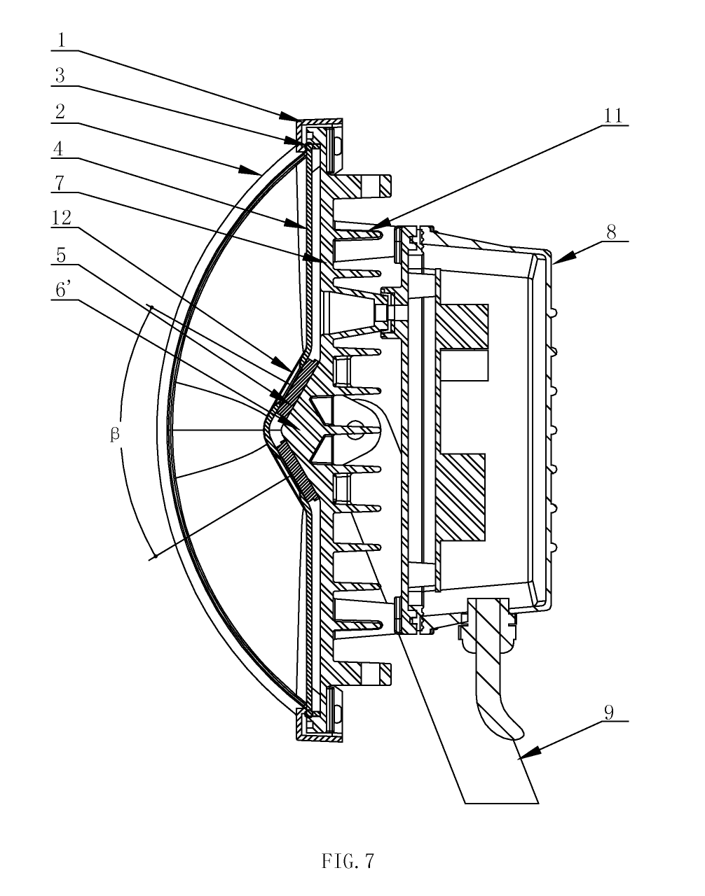

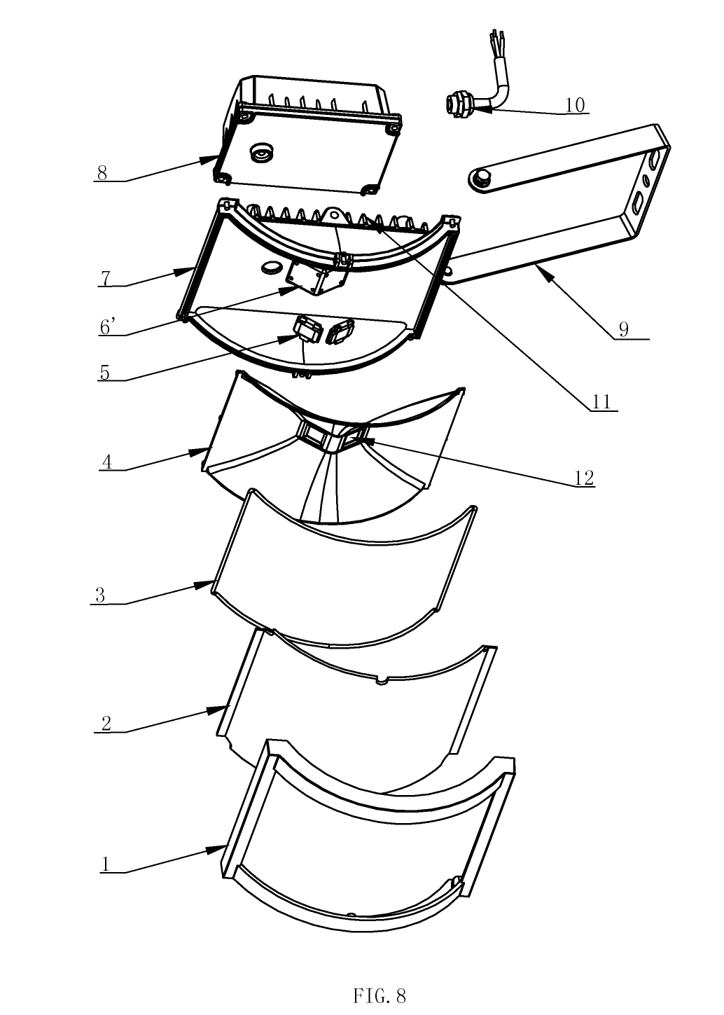

As shown in FIGS. 5 to 8, this embodiment differs from Embodiment 1 in that:

the lamp seat 6′ has a pair of symmetrical inclined planes symmetrically arranged up and down to be vertical to the ground.

The arrangement direction of the reflector cup 4 is just opposite to that of Embodiment 1 (that is, the reflector cup 4 is rotated by 90°). In this way, the two high-power integrated LED lamps 5 are respectively fixed on the upper and lower inclined planes of the lamp seat 6′. The two integrated LED lamps 5 are combined through grading to allow the reflector cup 4 to have a longitudinal projection angle of 180° and a transverse projection angle of 120°, i.e., allowing the fixture to have a longitudinal light emitting angle of 180° and a transverse light emitting angle of 120°.

1. An LED projector, capable of emitting light in 180°, comprising,
a projector body having a front surface, a back, and a center;
a power supply connected to the projector body;
a plurality of integrated LED lamps;
a reflector cup disposed on the front surface;
a lampshade; and
a lampshade frame;
a lamp seat, having a pair of symmetrical inclined planes, each inclined plane having a center line, is disposed in the center of the projector body, an angle between the vertical center lines of the two inclined planes is between 30° and 90°; and
two integrated LED lamps, each LED lamp being fixed on an inclined plane of the lamp seat,
wherein the reflector cup has a bulge fitted with the lamp seat, and the bulge has two light projection holes for receiving the integrated LED lamps.

2. The LED projector of claim 1, wherein the two inclined planes of the lamp seat are arranged left and right of the projector body, or arranged up and down of the projector body.

3. The LED projector of claim 1, wherein the angle between the vertical center lines of the two inclined planes is 60°.

4. The LED projector of claim 1, wherein the lampshade is fixed on the projector body by pressing the lampshade frame toward the projector body, and a sealing ring is provided between the lampshade and the projector body to form a waterproof and dustproof sealed structure.

5. The LED projector of claim 4, further comprising a plurality of longitudinal cooling blades attached to the back of the projector body.

6. The LED projector of claim 5, further comprising a mounting support assembly movably connected to the projector body for adjusting an illumination angle.

7. The LED projector of claim 6, wherein the power supply is provided with a waterproof connector connected to a power line.
